(19) United States
(12) Patent Application Publication
(10) Pub. No.: US 2026/0245401 A1
(43) Pub. Date: Aug. 20, 2026

(54) METHOD FOR BODY RE-IDENTIFICATION USING A MACHINE LEARNING MODEL, AND METHOD FOR TRAINING A MACHINE LEARNING MODEL FOR BODY RE-IDENTIFICATION

(71) Applicant: Orange, Issy-Les-Moulineaux (FR)

(72) Inventors: Lan WANG, Beijing (CN); Lei YU, Beijing (CN)

(21) Appl. No.: 19/156,296

(22) PCT Filed: Feb. 9, 2024
(86) PCT No.: PCT/IB2024/000051

§ 371 Date: Aug. 13, 2025

(30) Foreign Application Priority Data
Feb. 13, 2023 (WO) PCT/CN2023/075674

(51) Int. Cl. G06V 40/16; G06N 3/0464; G06V 10/764; G06V 10/77; G06V 10/774; G06V 10/82; G06V 40/10

(52) U.S. Cl. CPC G06V 40/173; G06N 3/0464; G06V 10/764; G06V 10/7715; G06V 10/774; G06V 10/82; G06V 40/103

(57) ABSTRACT

A method for training a machine learning model for body re-identification, where the machine learning model includes a feature map extraction module, an attention weighting mask generating module and a classifying module. The training method includes at least one iteration including: a first training phase which includes processing a first training dataset by the machine learning model and updating the feature extraction module, and a second training phase which includes processing a second training dataset, different from the first training dataset, by the machine learning model and updating the attention weighting mask generating module.

### CROSS-REFERENCE TO RELATED APPLICATIONS

This application is filed under 35 U.S.C. § 371 as the U.S. National Phase of Application No. PCT/IB2024/000051 entitled “METHOD FOR BODY RE-IDENTIFICATION USING A MACHINE LEARNING MODEL, AND METHOD FOR TRAINING A MACHINE LEARNING MODEL FOR BODY RE-IDENTIFICATION” and filed Feb. 9, 2024, and which claims priority to PCT/CN2023/075674 filed Feb. 13, 2023, each of which is incorporated by reference in its entirety.

### BACKGROUND

### Field

The present disclosure relates to image processing and relates more specifically to a method and device for body re-identification by using a machine learning model and to a method and device for training a machine learning model for body re-identification.

The present disclosure may for instance be used for applications such as intelligent security, intelligent video surveillance, criminal investigation assistance, etc.

### Description of the Related Technology

In the context of the present disclosure, body re-identification corresponds to evaluating whether a body represented in an image, referred to as “query image” in the context of body re-identification, is also represented in one or more other images, referred to as “target images” in the present disclosure (a.k.a. “gallery images” in the context of body re-identification). A body may correspond to a person, to an object (e.g. car, truck, etc.), etc. An image corresponds to a set of pixels which may be e.g. a digital photograph, or a digital frame extracted from a sequence of frames, i.e. a digital video.

In recent years, machine learning models have been increasingly used for person re-identification, leading to improved performance. Many methods focus on representation learning which aims at determining a characteristic representation of the person in the query image, which may take the form of a feature map representing the estimated main features supposedly characterizing the person to be re-identified in the target images. Typical distance or similarity metrics can then be employed to perform image matching between the characteristic representation and the target images.

However, such machine learning models, once trained, usually suffer from significant performance degradation due their limited generalization capabilities, which are due at least in part to the domain shift between the source domain (i.e. the domain in which the query image is acquired) and the target domain (i.e. the domain in which a target image is acquired). Indeed, the characteristic representation of the person, extracted from the query image, may strongly depend on the acquisition domain of the query image (e.g. posture of the person, light conditions, characteristics of the camera that has acquired the query image), and may therefore not be optimal for identifying the same person in a target image obtained in target domain which will in most practical cases differ from the source domain (the camera may be different and have different characteristics, the lightning conditions may be different, etc.). For example, the features of a person's backpack are more important in school scenarios than in supermarket scenarios.

Different solutions have been proposed to improve the generalization capabilities of the machine learning model. For instance, solutions based on transfer learning or unsupervised domain adaptation (UDA) have been proposed. However, these solutions require data of the target domain to fine-tune the machine learning model and such data of the target domain is not always available in real-world applications.

Other solutions proposed are referred to as domain generalization (DG) re-identification methods and aim at obtaining a generalizable characteristic representation of the person in the query image, i.e. a characteristic representation that tends to be domain-independent such that it can be used in target domains different from the source domain while still enabling good person re-identification performance.

An example of DG person re-identification method, referred to as query-adaptive convolution, QAConv, is disclosed in [QAConv2020]. The QAConv person re-identification method does enable domain generalization to some extent, without the need for data from the target domain(s), and the person re-identification performance is improved compared to many existing representation learning person re-identification methods. However, there is still a need for improved domain generalization capabilities to improve the person (or body) re-identification performance in a variety of different target domains.

### SUMMARY

The present disclosure aims at improving the situation. In particular, the present disclosure aims at addressing at least some of the limitations of the prior art discussed above. In particular, the present disclosure aims at proposing a DG body re-identification method with improved domain generalization capabilities.

For this purpose, and according to a first aspect, the present disclosure relates to a method for training a machine learning model for body re-identification, wherein the machine learning model comprises a feature map extraction module for processing an image representing a body, referred to as query image, to produce a feature map, an attention weighting mask generating module for processing the feature map to produce an attention weighting mask for weighting the feature map, and a classifying module for processing based on the weighted feature map another image, referred to as target image, to produce an evaluation of whether the body represented in the query image is present in said target image, wherein the training method comprises at least one iteration comprising:
a first training phase which uses a first training dataset, the first training dataset comprising a training query image representing a first body, a training target image and a presence indicator indicating whether the first body is represented in said training target image, wherein the first training phase comprises processing the first training dataset by the machine learning model, to produce an evaluation of whether the first body is represented in the training target image of the first training dataset and updating, based on said evaluation and on the presence indicator, the feature extraction module of the machine learning model,
a second training phase which uses a second training dataset different from the first training dataset, the second training dataset comprising a training query image representing a second body, a training target image and a presence indicator indicating whether the second body is represented in said training target image, wherein the second training dataset comprises processing the second training dataset by the machine learning model, to produce an evaluation of whether the second body is represented in the training target image of the second training dataset and updating, based on said evaluation and on the presence indicator, the attention weighting mask generating module of the machine learning model.

Hence, the proposed solution relies on a machine learning model having a specific architecture, including a feature map extraction module and an attention weighting mask generating module. Basically, the feature extraction module is to be used to extract from a query image a feature map of the body (e.g. person or object) represented in said query image (i.e. a characteristic representation of said body) and the attention weighting mask generating module is to be used to generate an attention weighting mask for the feature map. The attention weighting mask aims at weighting the features in the feature map to emphasize those feature that are generalizable to other domains and to deemphasize those features that are not generalizable to other domains. Hence, the attention weighting mask, when applied to the feature map, produces a weighted feature map focusing on generalizable features. The feature map extraction module may be optimized to e.g. extract features of the body including features that may be source-domain-specific, and the attention weighting mask generating module may be optimized to generalize the extracted features, by putting an emphasis on those extracted features that are generalizable.

While several training approaches may be applied to such a machine learning model, a preferred approach is a supervised learning approach in which the feature extraction module and the attention weighting mask generating module are trained separately on different training datasets, respectively a first training dataset and a second training dataset.

By considering a second training dataset for training the attention weighting mask module that is different from the first training dataset used for training the feature map extraction module (i.e. composed of different training images), the machine learning model is trained to handle different domains (i.e. different training datasets comprising training images in respective different domains) for the query image and the target image(s). This corresponds to a meta-learning approach in which the domain-shift is simulated during the training of the machine learning model, thereby resulting in a trained machine learning model that yields improved generalization capabilities. Also, optimizing separately the feature map extraction module and the attention weighting mask generating module prevents potential optimization conflicts that may otherwise occur when performing e.g. gradient-descent-based optimizations.

The training of the machine learning model therefore comprises a first training phase, during which the feature map extraction module is updated by processing the first training dataset, and a second training phase during which the attention weighting mask generating module is updated by processing the second training dataset. In some embodiments, the first training phase and the second training phase may be iterated e.g. until a predetermined stop criterion is satisfied, by varying the first training dataset and the second training dataset at each iteration.

In specific embodiments, the training method may further comprise one or more of the following optional features, considered either alone or in any technically possible combination.

In specific embodiments, the classifying module is updated during the second training phase based on the evaluation produced during said second training phase. As discussed above, an important aspect of the training method is that the feature extraction module and the attention weighting mask generating module are trained separately on respective different training datasets. While different embodiments may be considered for the training of the classifying module, the inventors have found that training the classifying module simultaneously with the attention weighting mask generating module yields better body re-identification performance results than training the classifying module separately or simultaneously with the feature extraction module.

In specific embodiments, the feature map comprises a plurality of channels, each channel comprising a spatial feature map, and the attention weighting mask generating module comprises:
a channel attention module which produces a channel attention weighting mask for weighting the channels of the feature map,
a spatial attention module which produces a spatial attention weighting mask for weighting each spatial feature map,
and the attention weighting mask corresponds to the combination of the channel attention weighting mask and of the spatial attention weighting mask.

In specific embodiments:
the first training dataset comprises a plurality of training target images and a plurality of respective presence indicators for the first body, and processing the first training dataset by the machine learning model comprises producing a plurality of evaluations associated respectively to the plurality of target training images of the first training dataset, and updating the feature map extraction module based on the plurality of evaluations and on the plurality of presence indicators; and/or
the second training dataset comprises a plurality of training target images and a plurality of respective presence indicators for the second body, and processing the second training dataset by the machine learning model comprises producing a plurality of evaluations associated respectively to the plurality of target training images of the second training dataset, and updating the attention weighting mask generating module based on the plurality of evaluations and on the plurality of presence indicators.

In specific embodiments:
the first training dataset comprises a plurality of query images representing respective different first bodies, a plurality of training target images and a plurality of respective presence indicators for each first body, and processing the first training dataset by the machine learning model comprises producing a plurality of evaluations associated respectively to the different first bodies, and updating the feature map extraction module based on the plurality of evaluations and on the plurality of presence indicators; and/or
the second training dataset comprises a plurality of query images representing respective different second bodies, a plurality of training target images and a plurality of respective presence indicators for each second body, and processing the second training dataset by the machine learning model comprises producing a plurality of evaluations associated respectively to the different second bodies, and updating the attention weighting mask generating module based on the plurality of evaluations and on the plurality of presence indicators.

In specific embodiments the first training phase uses a cross-entropy loss function and/or a focal loss function and/or the second training phase uses a cross-entropy loss function and/or a focal loss function.

In specific embodiments, at each iteration, the first training phase is carried out before the second training phase or, alternatively, the second training phase is carried out before the first training phase. Also, the order of the first training phase and the second training phase may remain the same from one iteration to another, or it may vary from one iteration to the other, for some iterations at least.

According to a second aspect, the present disclosure relates to a computer program product comprising instructions which, when executed by at least one processor, configure said at least one processor to carry out a training method according to any one of the embodiments of the present disclosure.

According to a third aspect, the present disclosure relates to a device for training a machine learning model for body re-identification, said training device comprising at least one processor and at least one memory, wherein said at least one processor is configured to carry out a training method according to any one of the embodiments of the present disclosure.

According to a fourth aspect, the present disclosure relates to a method for body re-identification, wherein body re-identification corresponds to evaluating whether a body represented in an image, referred to as query image, is represented in at least one other image, referred to as target image, wherein said body re-identification method uses a previously trained machine learning model which comprises a feature map extraction module, an attention weighting mask generating module and a classifying module. The body re-identification method comprises:
processing the query image by the feature map extraction module to produce a feature map associated to the body,
processing the feature map by the attention weighting mask generating module to produce an attention weighting mask, and weighting the feature map by the attention weighting mask to produce a weighted feature map associated to the body,
processing the at least one target image by the classifying module, based on the weighted feature map associated to the body, thereby producing an evaluation of whether the body is represented in said at least one target image.

In specific embodiments, the body re-identification method may further comprise one or more of the following optional features, considered either alone or in any technically possible combination.

In specific embodiments, the feature map comprises a plurality of channels, each channel comprising a spatial feature map, and the attention weighting mask generating module comprises:
a channel attention module which produces a channel attention weighting mask for weighting the channels of the feature map,
a spatial attention module which produces a spatial attention weighting mask for weighting each spatial feature map, and the attention weighting mask corresponds to the combination of the channel attention weighting mask and of the spatial attention weighting mask.

In specific embodiments, the feature extraction module and/or the attention weighting mask generating module and/or the classifying module comprises a convolutional neural network.

In specific embodiments, the classifying module comprises a multi-layer perceptron, MLP, classifier.

In specific embodiments, the machine learning model is trained by a training method according to any one of the embodiments of the present disclosure.

According to a fifth aspect, the present disclosure relates to a computer program product comprising instructions which, when executed by at least one processor, configure said at least one processor to carry out a body re-identification method according to any one of the embodiments of the present disclosure.

According to a sixth aspect, the present disclosure relates to a device for body re-identification comprising at least one processor and at least one memory, wherein said at least one processor is configured to carry out a body re-identification method according to any one of the embodiments of the present disclosure.

### BRIEF DESCRIPTION OF THE DRAWINGS

The invention will be better understood upon reading the following description, given as an example that is in no way limiting, and made in reference to the figures which show:

FIG. 1: a diagram representing the main phases of supervised learning for a machine learning model,

FIG. 2: a schematic representation of an exemplary embodiment of a training device,

FIG. 3: a schematic representation of an exemplary embodiment of a body re-identification device,

FIG. 4: a schematic representation of an exemplary embodiment of a machine learning model for body re-identification,

FIG. 5: a diagram representing the main steps of an exemplary embodiment of a body re-identification method which uses the machine learning model of FIG. 4,

FIG. 6: a schematic representation of an exemplary embodiment of an attention weighting mask generating module of the machine learning model of FIG. 4,

FIG. 7: a diagram representing the main steps of an exemplary embodiment of a training method for the machine learning model of FIG. 4,

FIG. 8: a schematic representation of different phases of an exemplary embodiment of the training method of FIG. 7.

In these figures, references identical from one figure to another designate identical or analogous elements. For reasons of clarity, the elements shown are not to scale, unless explicitly stated otherwise.

Also, the order of steps/phases represented in the figures is provided only for illustration purposes and is not meant to limit the present disclosure which may be applied with the same steps/phases executed in a different order.

### DETAILED DESCRIPTION OF CERTAIN ILLUSTRATIVE EMBODIMENTS

As indicated above, the present disclosure relates to body re-identification and relates more specifically to a machine learning model suitable for DG person re-identification, and to a method for training such a machine learning model. Also, the body to be re-identified may correspond to a person, to an object (e.g. a moving object such as a car, an animal, etc.), etc. In the following, we consider in a non-limitative manner that the body corresponds to a person, i.e. we consider the person re-identification case.

As introduced above, person re-identification corresponds to evaluating whether a person represented in a query image is also represented in one or more target images. An image corresponds generally to a set of pixels which may be e.g. a digital photograph, or a digital frame extracted from a sequence of frames, i.e. a digital video.

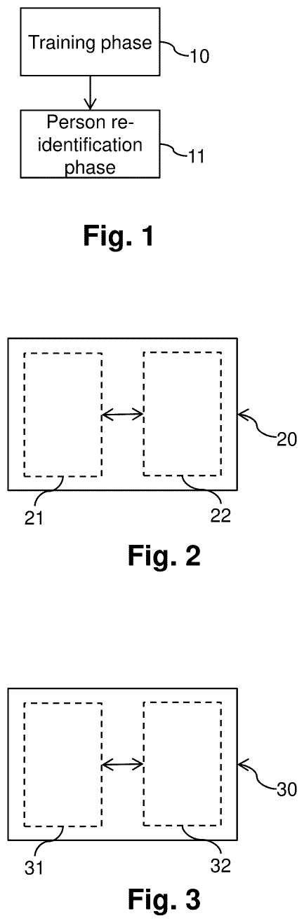

Different training methods may be considered for training the machine learning model. However, in preferred embodiments, the machine learning model is trained via supervised learning. In the following, we consider in a non-limitative manner that the machine learning model is trained via supervised learning. It is well known that, in such a case, the machine learning model undergoes mainly two different phases, as represented in FIG. 1, namely:
a training phase 10 during which the machine learning model is trained by using training data,
a person re-identification phase 11 during which the trained machine learning model is then applied to input images which include a query image, representing a person, and one or more target images in which the presence of the person represented in the query image is to be evaluated.

It is emphasized that the training phase 10 and the person re-identification phase 11 can be executed separately, independently from one another, the person re-identification phase 11 receiving as input the machine learning model trained during the training phase 10. For instance, the training phase 10 may be executed by a training device 20 and the person re-identification phase 11 may be executed by a person re-identification device 30. The training device 20 and the person re-identification device 30 may be separate, i.e. embedded in respective separate computing systems, or they may be embedded in a same computing system (in which case they can share hardware resources such as processors, memories, etc.).

FIG. 2 represents schematically an exemplary embodiment of a training device 20. As illustrated by FIG. 2, the training device 20 comprises one or more processors 21 and one or more memories 22. The one or more processors 21 may include for instance a central processing unit (CPU), a graphics processing unit (GPU), a neural processing unit (NPU), a digital signal processor (DSP), a field-programmable gate array (FPGA), an application specific integrated circuit (ASIC), etc. The one or more memories 22 may include any type of computer readable volatile and non-volatile memories (magnetic hard disk, solid-state disk, optical disk, electronic memory, etc.). The one or more memories 22 may store a computer program product, in the form of a set of program-code instructions to be executed by the one or more processors 21 in order to implement all or part of the steps of the training phase 10. Once the machine learning model has been trained, it can be stored in the one or more memories 22 and/or it can be stored in a remote database (not shown in the figures) and/or it can be sent to the person re-identification device 30.

FIG. 3 represents schematically an exemplary embodiment of a person re-identification device 30. As illustrated by FIG. 3, the person re-identification device 30 comprises one or more processors 31 and one or more memories 32. The one or more processors 31 may include for instance a CPU, a GPU, a NPU, a DSP, a FPGA, an ASIC, etc. The one or more memories 32 may include any type of computer readable volatile and non-volatile memories (magnetic hard disk, solid-state disk, optical disk, electronic memory, etc.). The one or more memories 32 may store a computer program product, in the form of a set of program-code instructions to be executed by the one or more processors 31 in order to use a trained machine learning model to perform person re-identification based on a query image and one or more target images. For instance, the trained machine learning model may be stored in the one or more memories 32 of the person re-identification device 30 after it has been retrieved from e.g. a remote database or from the training device 20.

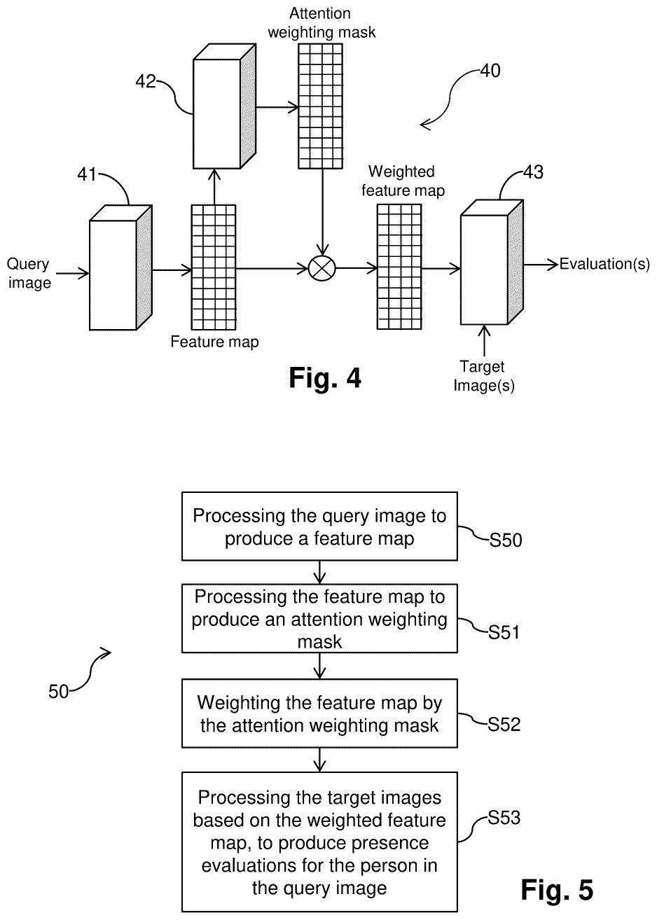

FIG. 4 represents schematically an exemplary embodiment of a machine learning model 40 for person re-identification. As illustrated by FIG. 4, the machine learning model 40, for instance a neural network, comprises:
a feature map extraction module 41,
an attention weighting mask generating module 42,
a classifying module 43.

FIG. 5 represents schematically the main steps of a method 50 for person re-identification which uses the machine learning model 40 of FIG. 4. The person re-identification method 50 is executed during the person re-identification phase 11 discussed above, for instance by a person re-identification device 30 as presented hereinabove.

As illustrated by FIG. 5, the person re-identification method 50 comprises a step S50 of processing the query image by the feature map extraction module 41 to produce a feature map representing the estimated main features supposedly characterizing the person represented in the query image, to be re-identified in the target images. Then, during a step S51, the feature map is processed by the attention weighting mask generating module 42 to produce an attention weighting mask to be used for weighting the feature map, in order to emphasize generalizable features and de-emphasize non generalizable features. During a step S52, the attention weighting mask is applied to the feature map, for instance as a pointwise product, thereby producing a weighted feature map of generalizable features of the person represented in the query image. The person re-identification method 50 then comprises a step S53 of processing each target image by the classifying module 43 by using the weighted feature map, thereby producing for each target image an evaluation of whether the person represented in the query image is represented in the considered target image. An evaluation of whether the person is represented in a target image corresponds to a classification of the target image as representing the person in the query image, or as not representing the person in the query image. Such an evaluation may for instance be representative of a similarity score, of a probability that the person in the query image is also present in the target image, etc.

The feature map extraction module 41 may be of any type suitable for extracting features of a person from an image representing this person. In some embodiments, the feature map extraction module 41 may correspond to a convolutional neural network, CNN.

Similarly, the classifying module 43 may be of any suitable type for performing a classification of images based on a feature map. In some embodiments, the classifying module 43 may comprise a CNN which uses the weighted feature map as convolutional kernel. The outputs of the CNN of the classifying module 43 may for instance be forwarded to a multi-layer perceptron, MLP, classifier of the classifying module 43.

In some embodiments, the feature map extraction module 41 and the classifying module 43 may comprise the same components as the QAConv machine learning model disclosed in [QAConv2020]. For instance, the feature map extraction module 41 may be based, at least in part, on the ResNet-50 CNN, which may be pre-trained on ImageNet, with e.g. an instance normalization layer appended to the last block of layer1 and layer2. The feature map may correspond to the output of the layer3 of the ResNet-50 CNN further processed by a 1×1 convolution with 64 channels.

The attention weighting mask generating module 42 may be of any type suitable for extracting weights emphasizing generalizable features. In some embodiments, the attention weighting mask generating module 42 may correspond to a CNN and/or an MLP.

Typically, the feature map extracted from the query image may comprise a plurality of channels, each channel comprising a spatial feature map. Each spatial feature map corresponds basically to a set of pixels of reduced size compared to the query image, and the feature map may comprise a plurality of such spatial feature maps associated to respective different channels. Basically, the channels correspond to different aspects defining the features of the person in the query image and may represent e.g. the silhouette, the posture, the upper body, etc. When the feature map comprises a plurality of channels having each a spatial feature map, the attention weighting mask may for instance seek to weight only the channel dimensions (e.g. putting the emphasis on some channels while deemphasizing the other channels) or to weight only the spatial dimensions (e.g. putting the emphasis on some pixels while deemphasizing the other pixels).

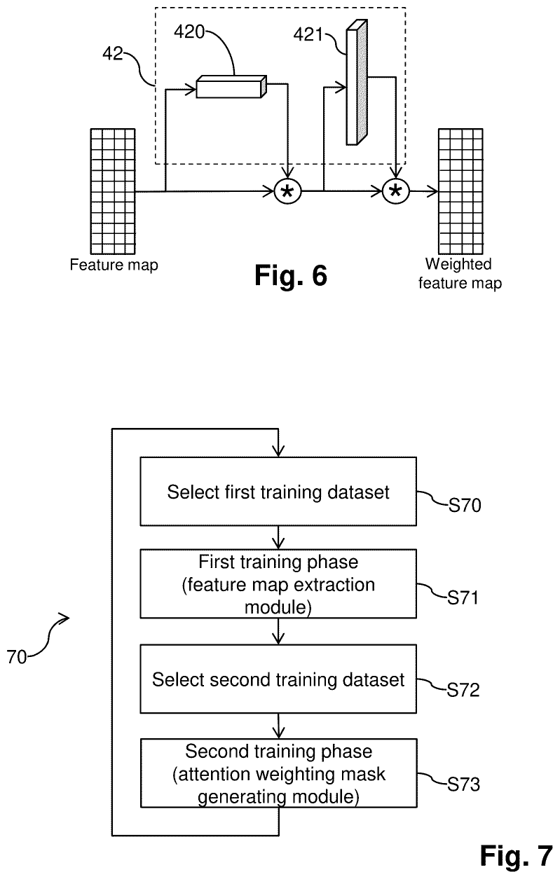

In some embodiments, the attention weighting mask seeks to weight both the channel dimensions and the spatial dimensions. FIG. 6 represents schematically an advantageous embodiment of the attention weighting mask generating module 42, which comprises in this non-limitative example:
a channel attention module 420 which produces a channel attention weighting mask for weighting the channels of the feature map,
a spatial attention module 421 which produces a spatial attention weighting mask for weighting each spatial feature map.

In the non-limitative example illustrated by FIG. 6, the channel attention module is applied to the feature map and produces the channel attention weighting mask, which is applied (e.g. as a pointwise product) to the feature map. The spatial attention module 421 is then applied to the feature map having the channels weighted by the channel attention weighting mask and produces the spatial attention weighting mask which is applied (e.g. as a pointwise product) to the feature map weighted by the channel attention weighting mask. Hence, the attention weighting mask corresponds to the combination of the channel attention weighting mask and of the spatial attention weighting mask. For instance, the channel attention module 420 may be based on the squeeze-and-excitation method which consists of space-based global average pooling and maximum pooling, while the space attention module may consist of channel-based global maximum pooling and global average pooling. For instance, the attention weighting mask generating module 42 may correspond to the convolutional block attention module, CBAM, proposed in [CBAM2018]. However, other attention-based methods may be used in other embodiments.

Different training methods may be considered for training the machine learning model 40. However, in preferred embodiments, the machine learning model 40 is trained via supervised learning by using training data. The training data comprises training images, which comprise both training query images representing different persons and training target images, and also reference data in the form of presence indicators identifying the person(s) represented in each training target image (among the persons represented in the training query images).

FIG. 7 represents schematically the main steps of an exemplary embodiment of a method 70 for training the machine learning model 40 for person re-identification. The training method 70 is executed during the training phase 10 discussed above, for instance by a training device 20 as presented hereinabove.

In the non-limitative example illustrated by FIG. 7, the training method 70 comprises several phases which are iterated until a predetermined stop criterion is satisfied. Generally speaking, the training method 70 may use any stop criterion known to the skilled person and the choice a specific stop criterion corresponds to a non-limitative specific embodiment of the training method 70. For instance, the iterations of the different phases of the training method 70 may stop once a predetermined number of iterations have been executed. It should be noted that, in other embodiments, the training method 70 may comprise a single iteration, resulting in each of the different phases being executed once.

In the non-limitative example illustrated by FIG. 7, the training method 70 comprises four main phases. More specifically, the training method 70 comprises:
a first selecting phase S70,
a first training phase S71,
a second selecting phase S72,
a second training phase S73.

It is emphasized that the order of the phases represented in FIG. 7 is provided for illustration purposes only and is not meant to limit the present disclosure which may be applied with the same phases executed in a different order. The only restriction is that the first selecting phase S70 needs to be executed before the first training phase S71 and the second selecting phase S72 needs to be executed before the second training phase S73. Apart from that, the order of the phases may vary. For instance, the first training phase S71 may be carried out before the second training phase S73 or, alternatively, the second training phase S73 may be carried out before the first training phase S71. Also, the order of the first training phase S71 and the second training phase S73 may remain the same from one iteration to another, or it may vary from one iteration to the other, for some iterations at least. In other examples, the first training phase S71 and the second training phase S73 may also be executed in parallel. It is also submitted that the first selecting phase S70 and the second selecting phase S72 may be executed separately or simultaneously.

The first selecting phase S70 comprises selecting a first training dataset. The first training dataset comprises a first training query image representing a first person, and a first training target image. The first training target image also has a first presence indicator indicating whether the first person, represented in the first training query image is also represented in said first training target image. Such a first presence indicator may for instance consist in a binary value (i.e. present/not present) provided as metadata or as a label to the first training target image. The first training dataset may also comprise a plurality of first training target images (with associated presence indicators) and/or a plurality of first training query images representing different respective first persons. If the first training dataset comprises a plurality of first training query images, each first training target image may comprise a plurality of first presence indicators associated respectively to the different first persons.

Similarly, the second selecting phase S72 comprises selecting a second training dataset. The second training dataset comprises a second training query image representing a second person, and a second training target image. The second training target image also has a second presence indicator indicating whether the second person, represented in the second training query image is also represented in said second training target image. The second training dataset may also comprise a plurality of second training target images (with associated presence indicators) and/or a plurality of second training query images representing different respective second persons. If the second training dataset comprises a plurality of second training query images, each second training target image may comprise a plurality of second presence indicators associated respectively to the different second persons.

Hence, the first training dataset and the second training dataset are similar in content (i.e. they both comprise one or more training query images and one or more a training target images with associated presence indicators(s)). In the following, the first (resp. second) training query image(s), the first (resp. second) training target image(s) and the first (resp. second) presence indicator(s) are simply referred to as respectively training query image(s), training target image(s) and presence indicator(s), for conciseness purposes.

However, while similar in content, the first training dataset and the second training dataset are different at each iteration, in that they are composed of different training images (i.e. there is no training image that is both in the first training dataset and in the second training dataset at each iteration). It should be noted that, while referred to by respectively “first” and “second”, the first person and the second person may correspond to a same person (but represented in different training query images).

It should be noted that the first selecting phase S70 and the second selecting phase S72 are optional, such that the training method 70 may comprise in some embodiments only the first training phase S71 and the second training phase S73. In such embodiments, the first training dataset and the second training dataset may for instance be determined beforehand and retrieved from e.g. a database or a memory 22 of the training device 20. In the following, we consider in a non-limitative manner that the training method 70 comprises a first selecting phase S70 and a second selecting phase S72, as illustrated by FIG. 7.

How the training images are generated is out of scope of the present disclosure, and it is submitted that the training of the machine learning model 40 may for instance be carried out by relying on existing publicly available datasets such as Market-1501, MSMT17, CUHK03, DukeMTMC-reID, etc., possibly in combination with data augmentation methods such as random occlusion, flipping, cropping, rotation, color jitter, etc.

The Market-1501 dataset includes 32668 labeled (i.e. with associated presence indicators) images acquired by 6 cameras, representing 1501 different persons. The Market-1501 dataset is split in a training set and in a test set. The training set of the Market-1501 dataset comprises 12936 images representing different 751 persons. The test set of the Market-1501 dataset comprises 19732 images representing 750 different persons. The training set and the test set of the Market-1501 dataset are each split in a query set (including images to be used as query images) and a gallery set (including images to be used as target images). The MSMT17, the CUHK03 and the DukeMTMC-reID datasets are similarly split in respective training sets (split in query sets and gallery sets) and test sets (split in query sets and gallery sets). For instance, it is possible to use an existing dataset, such as the Market-1501 dataset (or any of the MSMT17, CUHK03, DukeMTMC-reID, etc., datasets), as a source dataset for the first selecting phase S70 and the second selecting phase S72. For instance, at each iteration, the first training dataset may be selected (for instance randomly) in the training set of the source dataset (with the one or more training query images selected in the query set and the one or more training target images selected in the gallery set) while the second training dataset may be selected (for instance randomly) in the test set of the source dataset (with the one or more training query images selected in the query set and the one or more training target images selected in the gallery set).

The first training phase S71 comprises processing the first training dataset by the machine learning model 40, to produce an evaluation of whether the first person is represented in the training target image of the first training dataset and updating, based on said evaluation and on the presence indicator, the feature map extraction module 41 of the machine learning model. In particular, it is emphasized that the attention weighting mask generating module 42 is not updated during the first training phase S71. Typically, the training aims at updating the feature map extraction module 41 to progressively optimize a predetermined first loss function which compares each evaluation with the corresponding presence indicator. Typically, the behavior of the feature map extraction module 41 is defined by a set of parameters and updating the feature map extraction module 41 implies updating the values of said set of parameters. The updating of the feature map extraction module 41 may use any method known to the skilled person, for instance a gradient descent based method. For instance, the first training phase S71 may use a stochastic gradient descent, SGD, optimizer.

The second training phase S73 comprises processing the second training dataset by the machine learning model 40, to produce an evaluation of whether the second person is represented in the training target image of the second training dataset and updating, based on said evaluation and on the presence indicator, the attention weighting mask generating module 42 of the machine learning model. In particular, it is emphasized that the feature map extraction module 41 is not updated during the second training phase S73. Typically, the training aims at updating the attention weighting mask generating module 42 to progressively optimize a predetermined second loss function which compares each evaluation with the corresponding presence indicator. Typically, the behavior of the attention weighting mask generating module 42 is defined by a set of parameters and updating the attention weighting mask generating module 42 implies updating the values of said set of parameters. The updating of the attention weighting mask generating module 42 may use any method known to the skilled person, for instance a gradient descent based method such as e.g. an SGD optimizer.

Generally speaking, the classifying module 43 of the machine learning model 40 may be updated separately, i.e. during a third training phase (not represented in the figures), or during the first training phase S71 or the second training phase S73. However, in some embodiments, the classifying module 43 is updated during the second training phase S73 (and not during the first training phase S71), together with the attention weighting mask generating module 42, based on the same evaluation(s). Indeed, the inventors have found that better person re-identification performance results could be obtained by training the classifying module 43 simultaneously with the attention weighting mask generating module 42. Typically, the behavior of the classifying module 43 is defined by a set of parameters and updating the classifying module 43 implies updating the values of said set of parameters.

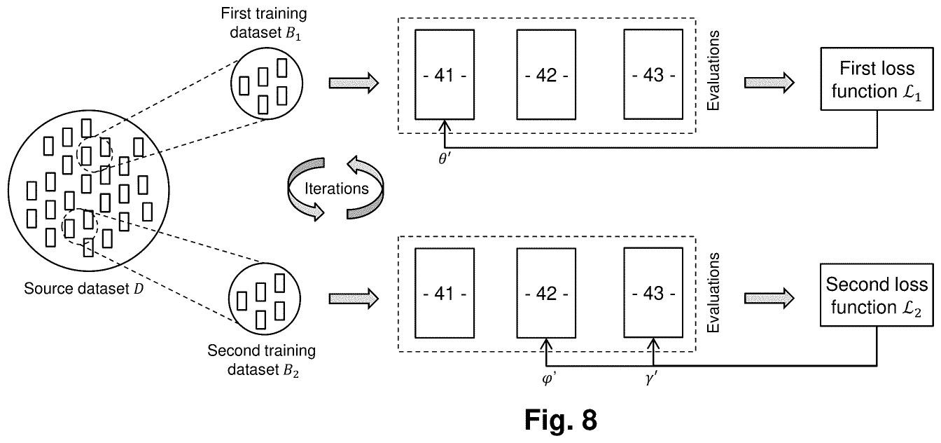

An exemplary pseudo-code implementation for an exemplary embodiment of the training method 70 is provided below. A corresponding schematic representation of this exemplary embodiment is also provided in FIG. 8. In this example, the first training dataset (denoted B₁) and the second training dataset (denoted B₂) are selected in a source dataset (denoted D) and the classifying module 43 is updated during the second training phases S73. The feature map extraction module 41 is represented by a function ƒ_{θ}(·) defined by a set of parameters θ, the attention weighting mask generating module 42 is represented by a function g_{φ}(·) defined by a set of parameters φ and the classifying module 43 is represented by a function h_{γ}(·) defined by a set of parameters γ. The first loss function is denoted [symbol] and the second loss function is denoted [symbol] . It should be noted that, while referred by respectively [symbol] and [symbol] , the first loss function and the second loss function may correspond to a same function. Also, the operator * denotes a pointwise product.

```
Input: source dataset D
Output: function f_{θ}(•), function g_{φ}(•), function h_{γ}(•)
  for all iterations do
    // first selecting phase S70
    select randomly B₁ in D
    // first training phase S71
    F = f_{θ}(B₁)
    F₁ = g_{φ}(F) * F
    L₁ = [symbol]   (h_{γ}(F₁))
    update θ with L₁
    // second selecting phase S72
    select randomly B₂ in D
    // second training phase S73
    F = f_{θ}(B₂)
    F₂ = g_{φ}(F) * F
    L₂ = [symbol]   (h_{γ}(F₂))
    update φ and γ with L₂
  endfor
```

For instance, the set of parameters θ may be updated, during the first training phase S71, according to the following expression:

$${θ}^{′} = θ - 0.1 \times {L}_{R} \times \frac{\partial {ℒ}_{1}}{\partial θ}$$

expression in which L_{R} corresponds to the learning rate.

The set of parameters φ and γ may be updated, during the second training phase S73, according to the following expressions:

$$\{ \begin{matrix}{φ}^{′} = φ - {L}_{R} \times \frac{\partial {ℒ}_{2}}{\partial φ} \\ {γ}^{′} = γ - {L}_{R} \times \frac{\partial {ℒ}_{2}}{\partial γ}\end{matrix}$$

In these non-limitative examples, the resulting learning rate during the second training S73 (L_{R} for updating φ and γ) is 10 times greater than during the first training phase S71 (0.1×L_{R} for updating θ). In some embodiments, the learning rate for updating the attention weighting mask generating module 42 (and possibly the classifying module 43) is greater than the learning rate for updating the feature map extraction module 41, as the inventors found that it yielded better results, for instance at least 10 times greater.

In some embodiments, the first loss function (resp, the second loss function) comprises a cross-entropy loss function [symbol] and/or a focal loss function [symbol] . When both a cross-entropy loss function [symbol] and a focal loss function [symbol] are used, they are for instance linearly combined e.g. added together.

For instance, the cross-entropy loss function [symbol] may be defined as follows:

$${\hat{p}}_{ij} = \{ \begin{matrix}{p}_{ij} & if {y}_{ij} = 1 \\ 1 - {p}_{ij} & otherwise\end{matrix}$$

$${ℒ}_{C E} ( {\hat{p}}_{i j} ) = - log ( {\hat{p}}_{i j} )$$

expressions in which:
yᵢⱼ corresponds to the presence indicator associated to the (first or second) person of index i (represented in the considered training query image) for the training target image of index j,
pᵢⱼ corresponds to the evaluation determined for the (first or second) person of index i (represented in the considered training query image) for the training target image of index j.

For instance, the focal loss function L_{F} may be defined as follows:

$${α}_{ij} = \{ \begin{matrix}α & if {y}_{ij} = 1 \\ 1 - α & otherwise\end{matrix}$$

$${ℒ}_{F} ( {\hat{p}}_{i j} ) = - {{α}_{i j} ( 1 - {\hat{p}}_{i j} )}^{β} log ( {\hat{p}}_{i j} )$$

expressions in which 0<α<1 and β are predetermined coefficients.

When the first training dataset (resp, the second training dataset) comprises a plurality of training target images, it is for instance possible to compute a first loss function value L₁ (resp. a second loss function value L₂) for each training target image (i.e. for each evaluation and each corresponding presence indicator). The resulting plurality of first loss function values L₁ (resp. second loss function values L₂) may for instance be added to compute a mean first loss function value L̅₁ (resp. a mean second loss function value L̅₂) over the training target images. However, other methods may be used to combine the plurality of first loss function values L₁ (resp. second loss function values L₂) and the choice of a specific method corresponds to a non-limitative specific embodiment.

When the first training dataset (resp, the second training dataset) comprises a plurality of training query images representing respective different first persons (resp. second persons), it is for instance possible to compute a first loss function value L₁ (resp. a second loss function value L₂) for each training query image. The resulting plurality of first loss function values L₁ (resp. second loss function values L₂) may for instance be added to compute a mean first loss function value L̅₁ (resp. a mean second loss function value L̅₂) over the training query images. However, other methods may be used to combine the plurality of first loss function values L₁ (resp. second loss function values L₂) and the choice of a specific method corresponds to a non-limitative specific embodiment.

Preferably, the first training dataset (resp, the second training dataset) comprises both a plurality of training query images and a plurality of training target images. In such a case, a first loss function value L₁ (resp. a second loss function value L₂) may be computed for each pair training query image/training target image of the first training dataset (resp, the second training dataset), and the resulting plurality of first loss function values L₁ (resp. second loss function values L₂) may for instance be linearly combined to produce a first loss function value \tilde{L}₁ (resp. a second loss function value \tilde{L}₂) which may be used to update the feature map extraction module 41 (resp, the attention weighting mask generating module 42 and, optionally, the classifying module 43).

We provide hereinbelow experiment results which demonstrate the effectiveness of the proposed solution, compared to the QAConv method presented in [QAConv2020].

In these experiments, the feature map extraction module is based on a ResNet-50 pre-trained on ImageNet, with an instance normalization layer appended to the last block of layer1 and layer2. The layer3's feature map of the ResNet-50 is sent to the attention weighting mask generating module 42. At each iteration, the first training dataset comprises 8 training query images selected in the query set of the training set and all the training target images of the gallery set of the training set. Similarly, at each iteration, the second training dataset comprises 8 training query images selected in the query set of the test set and all the training target images of the gallery set of the test set. The optimization was performed by using an SGD optimizer with a momentum of 0.9 and a weight decay of 5×10⁻⁴. An initial learning rate of 5×10⁻⁴ is applied for the feature map extraction module 41 and 5×10⁻³ for the attention weighting mask generating module 42 and the classifying module 43. They are decayed by 0.1 after 20 iterations, and the training stops at 30 iterations (stop criterion).

The QAConv method and the proposed solution, referred to as “MetAConv” in the sequel, are compared via cross-dataset evaluation, by using the training set of one among the datasets Market-1501, MSMT17, CUHK03 and DukeMTMC-reID, and by using the test set of a different dataset for the performance evaluation. This cross-dataset evaluation follows the direct single-source DG benchmark, and all evaluations followed the single-query evaluation protocol and used mean Average Precision (mAP) and Cumulative Matching Characteristic (CMC) at Rank-1 as the performance evaluation metrics.

Table 1 shows the results obtained by using the training set of the dataset Market-1501 for the training and by performing the performance evaluations on the test sets of the datasets MSMT17, CUK03 and DukeMTMC-reID, respectively.

TABLE 1

| | Training: Market-1501 | | | | | |
|---|---|---|---|---|---|---|
| | Test: MSMT17 | | Test: CUHK03 | | Test: DukeMTMC-reID | |
| Method | Rank-1 | mAP | Rank-1 | mAP | Rank-1 | mAP |
| QAConv | 22.6 | 7.0 | 9.9 | 8.6 | 48.8 | 28.7 |
| MetAConv | 39.4 | 14.1 | 17.4 | 15.5 | 58.2 | 38.1 |

Table 2 shows the results obtained by using the training set of the dataset MSMT17 for the training and by performing the performance evaluations on the test sets of the datasets Market-1501, CUK03 and DukeMTMC-reID, respectively.

TABLE 2

| | Training: MSMT17 | | | | | |
|---|---|---|---|---|---|---|
| | Test: Market-1501 | | Test: CUHK03 | | Test: DukeMTMC-reID | |
| Method | Rank-1 | mAP | Rank-1 | mAP | Rank-1 | mAP |
| QAConv | 69.7 | 40.7 | 15.9 | 14.3 | 62.7 | 42.4 |
| MetAConv | 73.8 | 43.8 | 18.4 | 17.3 | 66.8 | 46.8 |

Hence, as illustrated by Table 1 and Table 2, the proposed solution outperforms the QAConv method. It should be noted that inventors have also conducted similar experiments with other DG person re-identification methods, which have also demonstrated the effectiveness of the proposed solution. Similar experiments have also been conducted with UDA person re-identification methods (which fine-tune the machine learning model by using data of the test domain) which have demonstrated that the proposed solution enables to achieve similar results in some cases.

It is emphasized that the present disclosure is not limited to the above exemplary embodiments. Variants of the above exemplary embodiments are also within the scope of the present invention.

For instance, the present disclosure has been given by considering mainly the person re-identification case. However, as indicated above, the present disclosure applies more generally to body re-identification, and may also be applied for the re-identification of e.g. objects such as moving cars, trucks, etc.

### REFERENCES

[QAConv2020] Shengcai Liao and Ling Shao. “Interpretable and generalizable person re-identification with query-adaptive convolution and temporal lifting”. In Computer Vision-ECCV 2020: 16th European Conference, Glasgow, UK, Aug. 23-28, 2020, Proceedings, Part XI 16, pages 456-474. Springer, 2020.
[CBAM2018] Sanghyun Woo, Jongchan Park, Joon-Young Lee, and In So Kweon. “CBAM: Convolutional block attention module”. In Proceedings of the European conference on computer vision (ECCV), pages 3-19, 2018.

1. A method for training a machine learning model for body re-identification,
the model comprising a feature map extraction module, an attention weighting mask generating module, and a classifying module, the method comprising at least one iteration comprising a first training phase updating the feature extraction module of the machine learning model based on a first dataset comprising a query image, a target image and a first presence indicator,
wherein the at least one iteration comprises a second training phase, using a different dataset comprising a training query image, a training target image and a second presence indicator, updating the attention weighting mask generating module based on an evaluation of whether a body in the training query image is present in the training target image.

2. The training method according to claim 1, wherein the classifying module is updated during the second training phase based on the evaluation produced during the second training phase.

3. The training method according to claim 1, wherein the feature map comprises a plurality of channels, each channel comprising a spatial feature map, and the attention weighting mask generating module comprises:
a channel attention module which produces a channel attention weighting mask for weighting the channels of the feature map, and
a spatial attention module which produces a spatial attention weighting mask for weighting each spatial feature map,
wherein the attention weighting mask corresponds to the combination of the channel attention weighting mask and of the spatial attention weighting mask.

4. The training method according to claim 1, wherein:
the first training dataset comprises a plurality of training target images and a plurality of respective presence indicators for the first body, and processing the first training dataset by the machine learning model comprises producing a plurality of evaluations associated respectively to the plurality of target training images of the first training dataset, and updating the feature map extraction module based on the plurality of evaluations and on the plurality of presence indicators; and/or
the second training dataset comprises a plurality of training target images and a plurality of respective presence indicators for the second body, and processing the second training dataset by the machine learning model comprises producing a plurality of evaluations associated respectively to the plurality of target training images of the second training dataset, and updating the attention weighting mask generating module based on the plurality of evaluations and on the plurality of presence indicators.

5. The training method according to claim 1, wherein:
the first training dataset comprises a plurality of query images representing respective different first bodies, a plurality of training target images and a plurality of respective presence indicators for each first body, and processing the first training dataset by the machine learning model comprises producing a plurality of evaluations associated respectively to the different first bodies, and updating the feature map extraction module based on the plurality of evaluations and on the plurality of presence indicators; and/or
the second training dataset comprises a plurality of query images representing respective different second bodies, a plurality of training target images and a plurality of respective presence indicators for each second body, and processing the second training dataset by the machine learning model comprises producing a plurality of evaluations associated respectively to the different second bodies, and updating the attention weighting mask generating module based on the plurality of evaluations and on the plurality of presence indicators.

6. The training method according to claim 1, wherein:
the first training phase uses a cross-entropy loss function and/or a focal loss function; and/or
the second training phase uses a cross-entropy loss function and/or a focal loss function.

7. The training method according to claim 1, wherein, at each iteration, the first training phase is carried out before the second training phase or, alternatively, the second training phase is carried out before the first training phase.

8. A non-transitory computer-readable medium containing instructions which, when executed by at least one processor, cause the at least one processor to carry out the training method according to claim 1.

9. A device for training a machine learning model for body re-identification, the training device comprising at least one processor and at least one memory, wherein the at least one processor is configured to carry out the training method according to claim 1.

10. A method for body re-identification using a machine learning model trained according to claim 1, the method comprising:
processing a query image, by the feature map extraction module to produce a feature map,
weighting the feature map using an attention weighting mask produced by the attention weighting mask generating module, and
processing at least one target image by the classifying module based on the weighted feature map to evaluate whether the body is present in the target image.

11. The body re-identification method according to claim 10, wherein the feature map comprises a plurality of channels, each channel comprising a spatial feature map, and the attention weighting mask generating module comprises:
a channel attention module which produces a channel attention weighting mask for weighting the channels of the feature map, and
a spatial attention module which produces a spatial attention weighting mask for weighting each spatial feature map,
wherein the attention weighting mask corresponds to the combination of the channel attention weighting mask and of the spatial attention weighting mask.

12. The body re-identification method according to claim 10, wherein the feature extraction module and/or the attention weighting mask generating module and/or the classifying module comprises a convolutional neural network.

13. The body re-identification method according to claim 10, wherein the classifying module comprises a multi-layer perceptron classifier.

14. (canceled)

15. A non-transitory computer-readable medium containing instructions which, when executed by at least one processor, cause the at least one processor to carry out the body re-identification method according to claim 10.

16. A device for body re-identification comprising at least one processor and at least one memory, wherein the at least one processor is configured to carry out the body re-identification method according to claim 10.
